(19) United States
(12) Patent Application Publication
(10) Pub. No.: US 2014/0310303 A1
(43) Pub. Date: Oct. 16, 2014

(54) ELECTRONIC DEVICE WITH SERVER MANAGEMENT SYSTEM AND METHOD THEREOF

(71) Applicant: HON HAI PRECISION INDUSTRY CO., LTD., New Taipei (TW)

(72) Inventor: YI-YAO WANG, New Taipei (TW)

(73) Assignee: HON HAI PRECISION INDUSTRY CO., LTD., New Taipei (TW)

(21) Appl. No.: 14/093,050

(22) Filed: Nov. 29, 2013

(30) Foreign Application Priority Data
Apr. 16, 2013 (TW) 102113459

(51) Int. Cl. G06F 17/30

(52) U.S. Cl. CPC G06F 17/30979
USPC 707/769

(57) ABSTRACT

A server management method includes controlling a display unit of an electronic device to display a management interface to input query information comprising a server name and a component name. The query information input from the management interface is analyzed, and the corresponding component name and the corresponding server name are obtained. A target attribute from a data tree is obtained according to the component name and the server name. A function corresponding to the target attribute is executed and a corresponding attribute list is displayed on the management interface.

### BACKGROUND

1. Technical Field

The present disclosure relates to management systems, and particularly to a server management system, an electronic device, and a method.

2. Description of Related Art

As is known, a number of servers working together constitute a server farm. Usually, a server farm is managed by a management system based on a server management command line protocol (SMCLP). In detail, the management system is run on a management device, and the management device is connected to all servers of the server farm via the SMCLP. The management device provides an SMCLP management interface, and a user can search attributes/statuses of components of each server via the SMCLP management interface. The management system needs a common information model object manager (CIMOM) database to store corresponding data. However, the CIMOM database is complex and reduces response speed of the management system.

Therefore, an electronic device with a server management system that overcomes the described limitations is needed.

### BRIEF DESCRIPTION OF THE DRAWINGS

Many aspects of the present disclosure are better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the views.

FIG. 1 is a block diagram of an embodiment of an electronic device.

FIG. 2 is a schematic diagram of a management interface displayed by the electronic device of FIG. 1.

FIG. 3 is a schematic diagram of a data tree provided by the electronic device of FIG. 1.

FIG. 4 is a detailed diagram of the data tree of FIG. 3.

FIG. 5 is a flowchart illustrating an embodiment of a server management method.

### DETAILED DESCRIPTION

Embodiments of the present disclosure will be described with reference to the accompanying drawings. The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

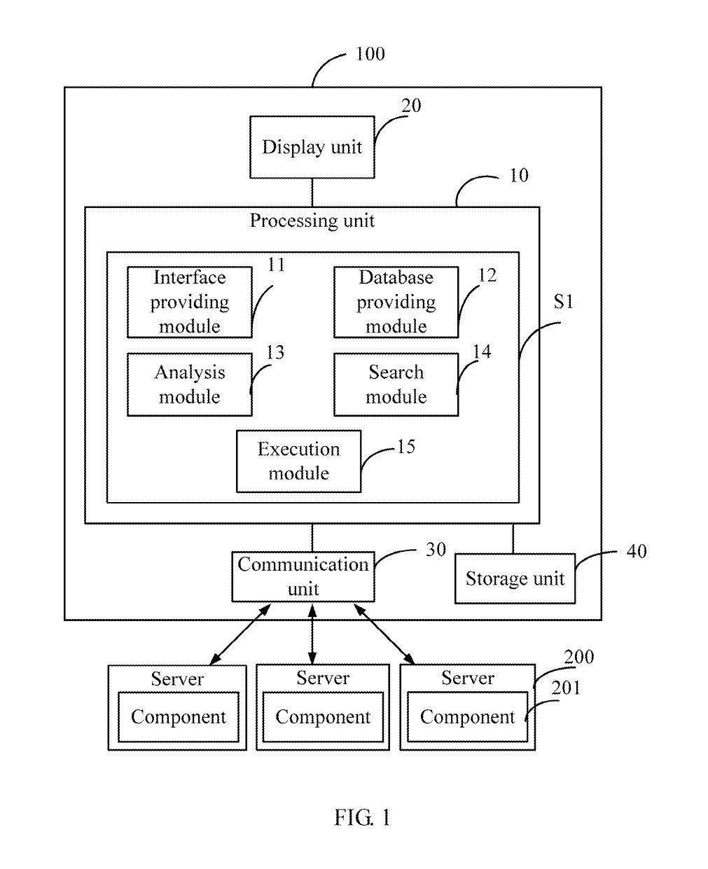

FIG. 1 shows a block diagram of an electronic device 100. The electronic device 100 includes a processing unit 10, a display unit 20, a communication unit 30, and a storage unit 40. The communication unit 30 is used to communicate with a number of servers 200. Each server 200 includes a number of components 201. The electronic device 100 can be, but is not limited to be, a portable computer, a tablet computer, or a desktop computer. The communication unit 30 can be a wired communication module or a wireless communication module. The processing unit 10 can be, but is not limited to be, a central processing unit, a single chip, or a digital signal processor. The display unit 20 can be, but is not limited to be, a liquid crystal display, a touch screen, or an electronic paper.

The processing unit 10 is used to execute a server management system S1. The server management system S1 includes an interface providing module 11, a database providing module 12, an analysis module 13, a search module 14, and an execution module 15. The server management system S1, which is a software program stored in the storage unit 40, can be called and executed by the processing unit 10. In another embodiment, the server management system Si is burned into the processing unit 10.

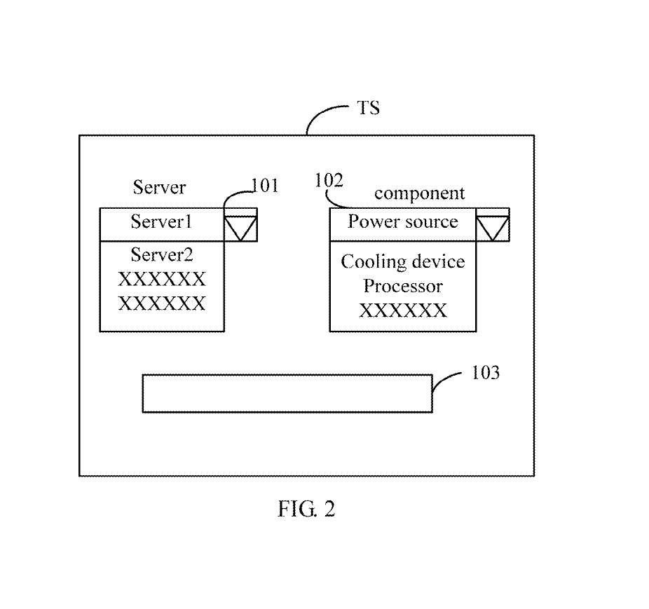

The interface providing module 11 is used to provide a management interface TS and control the display unit 20 to display the management interface TS. The management interface TS allows a user to input query information, such as a server name and a component name of the server. As shown in FIG. 2, the management interface TS includes a server selection box 101 and a component selection box 102. The server selection box 101 and the component selection box 102 are used to select a server and a component of the server, respectively. Therefore, if a user wants to search for an attribute of a component of a server, the user can select the server name via the server selection box 101 and the component name of the selected server via the component selection box 102. In the embodiment, the management interface TS also includes an input box 103 for inputting the server name and the component name directly.

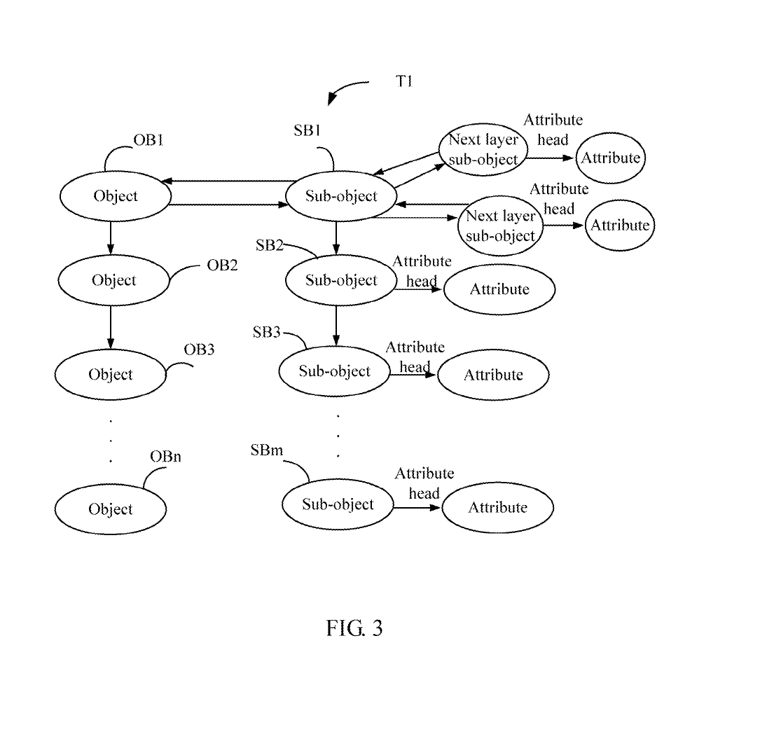

As shown in FIG. 3, the database providing module 12 is used to provide a data tree T1 and a number of functions. The data tree T1 includes a number of objects OB1 . . . OBn linked in series. Each of the objects OB1-OBn is linked to a number of sub-objects SB1 . . . SBm correspondingly. The sub-objects SB1-SBm of the same object are linked in series, and each of the sub-objects SB1-SBm is also linked to at least one next layer sub-object or an attribute. For example, if one of the sub-objects SB1-SBm comprises at least one next layer sub-object, the one of the sub-objects SB1-SBm is linked to the next layer sub-object. If one of the sub-objects SB1-SBm does not include any next layer sub-object, the one of the sub-objects SB1-SBm is linked to its attribute. In the embodiment, each function corresponds to one of the attributes.

In the embodiment, the database providing module 12 is a database recording the data tree T1 and the functions and is stored in the storage unit 40.

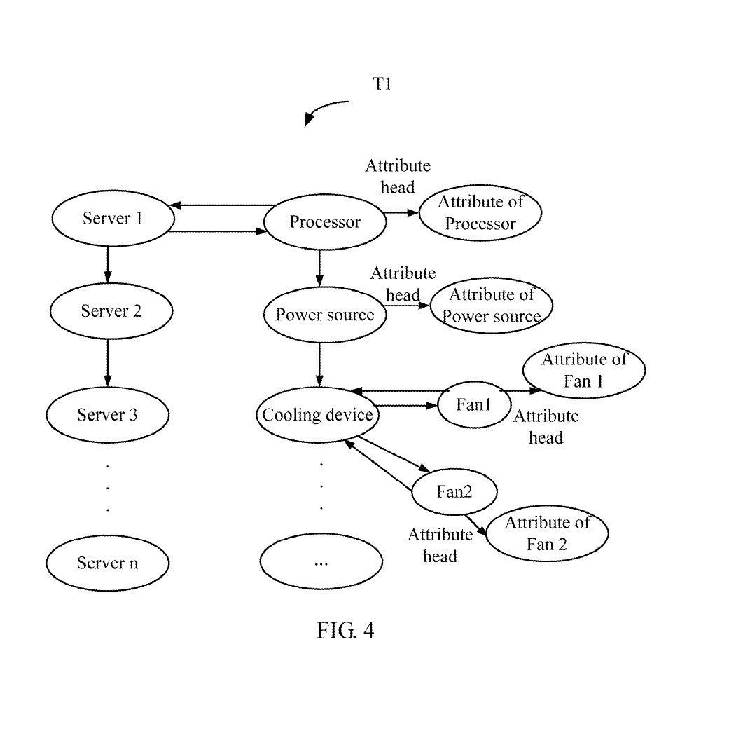

Also referring to FIG. 4, the objects OB1-OBn are different servers 200. The sub-objects SB1-SBm are different components of one server 200, such as a power source, a cooling device, or the like. If one of the sub-objects SB1-SBm includes a next layer sub-object, the one of the sub-objects SB1-SBm is linked to the next layer sub-object. For example, a cooling device may include a first fan Fan1 and a second fan Fan2. Thus, the first fan Fan1 and the second fan Fan2 are the next layer sub-objects. If one sub-object does not include a next layer sub-object, then the sub-object is linked to a corresponding attribute via an attribute head. In the embodiment, the attribute head records a location of the attribute in the data tree T1.

The analysis module 13 is used to analyze the query information input from the management interface TS by the user and obtain the component name and the server name according to the query information.

The search module 14 is used to obtain a target attribute from the data tree T1 according to the component name and the server name. In detail, the search module 14 determines the server of the data tree T1 according to the server name and determines the component linked to the server of the data tree T1 according to the component name, and then determines whether an attribute linked to the selected component is the target attribute and obtains the target attribute from the data tree T1.

The execution module 15 is used to execute a function corresponding to the target attribute obtained from the data tree T1 by the search module 14, thereby producing an attribute list, and display the attribute list on the management interface TS.

In the embodiment, the attribute of one component is a status of the component. For example, when the component is a fan, the status of the component includes a rotation speed. When the component is a central processing unit, the status of component includes a temperature and an occupancy rate. The attribute list includes the statuses of all the components. Therefore, the attribute can be searched quickly in the data tree T1

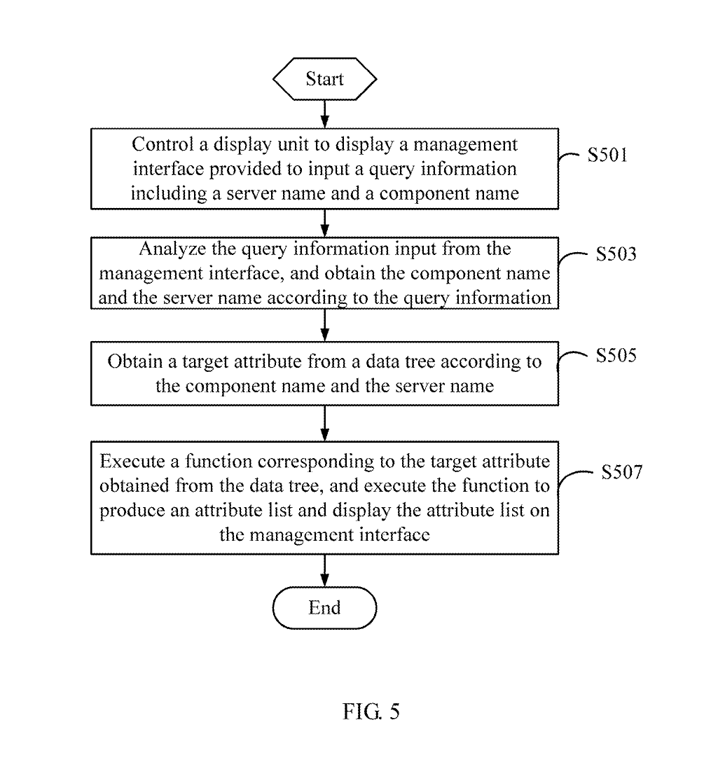

FIG. 5 shows a flowchart of a server management method. The server management method is applied in the electronic device 100. In step S501, the interface providing module 11 controls the display unit to display the management interface IS.

In step S503, the analysis module 13 analyzes the query information input from the management interface TS by the user and obtains the component name and the server name from the query information.

In step S505, the search module 14 obtains the corresponding target attribute from the data tree T1 according to the component name and the server name.

In step S507, the execution module 15 produces an attribute list and displays the attribute list on the management interface TS.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. A server management system, configured to manage a plurality of servers, comprising:
an interface providing module configured to provide a management interface and control a display unit of an electronic device to display the management interface, wherein, the management interface is provided to input a query information by a user, the query information comprises a component name and a server name from;
a database providing module configured to provide a data tree and a number of functions, wherein, the data tree comprises a plurality of objects linked in series, each one of the objects is linked to a number of sub-objects, each one of the sub-objects is further linked to next layer sub-objects or an attribute, the functions are correspond to the attributes one by one;
an analysis module configured to analyze the query information input from the management interface by the user, and obtain the component name and the server name according to the query information;
a search module configured to obtain a target attribute from the data tree according to the component name and the server name;
an execution module configured to execute a function corresponding to the target attribute obtained from the data tree by the search module, and execute the function to produce an attribute list and display the attribute list on the management interface; and
a processing unit configured to execute the interface providing module, the database providing module, the analysis module, the search module, and the execution module.

2. The system according to claim 1, wherein the objects of the data tree are different servers, the sub-objects are different components of the server.

3. The system according to claim 1, wherein the management interface comprises a server selection box and a component selection box, the server selection box and the component selection box are respectively provided to select a server and a component of the server and then produce the query information comprising the server name and the component name.

4. The system according to claim 3, wherein the management interface further comprises an input box provided for inputting the server name and the component name to input the query information directly.

5. The system according to claim 1, wherein the search module obtains the target attribute from the data tree according to the component name and the server name comprises: the search module determines the server of the data tree according to the server name and determines the component linked to the server of the data tree according to the component name, and then determines an attribute linked to the selected component is the target attribute and obtains the target attribute from the data tree.

6. An electronic device for managing a plurality of servers, comprising:
a communication unit configured to connect the plurality of servers;
a display unit; and
a processing unit comprising:
an interface providing module configured to provide a management interface and control a display unit of an electronic device to display the management interface, wherein, the management interface is provided to input a query information by a user, the query information comprises a component name and a server name;
a database providing module configured to provide a data tree and a number of functions, wherein, the data tree comprises a plurality of objects linked in series, each one of the objects is linked to a number of sub-objects, each one of the sub-objects is further linked to next layer sub-objects or an attribute, the functions are correspond to the attributes one by one;
an analysis module configured to analyze the query information input from the management interface by the user, and obtain the component name and the server name according to the query information;
a search module configured to obtain a target attribute from the data tree according to the component name and the server name; and
an execution module configured to execute a function corresponding to the target attribute obtained from the data tree by the search module, and execute the function to produce an attribute list and display the attribute list on the management interface.

7. The electronic device according to claim 6, wherein the objects of the data tree are different servers, the sub-objects are different components of the server.

8. The electronic device according to claim 6, wherein the management interface comprises a server selection box and a component selection box, the server selection box and the component selection box are respectively provided to select a server and a component of the server and then produce the query information comprising the server name and the component name.

9. The electronic device according to claim 8, wherein the management interface further comprises an input box provided for inputting the server name and the component name to input the query information directly.

10. The electronic device according to claim 6, wherein the search module obtains the target attribute from the data tree according to the component name and the server name comprises: the search module determines the server of the data tree according to the server name and determines the component linked to the server of the data tree according to the component name, and then determines an attribute linked to the selected component is the target attribute and obtains the target attribute from the data tree.

11. A server management method comprising:
controlling a display unit of an electronic device to display a management interface provided to input a query information comprising a server name and a component name;
analyzing the query information input from the management interface, and obtaining the component name and the server name according to the query information;
obtaining a target attribute from a data tree according to the component name and the server name; and
invoking a function corresponding to the target attribute obtained from the data tree, and executing the function to produce an attribute list and displaying the attribute list on the management interface.

12. The method according to claim 11, wherein the step of obtaining a target attribute from a data tree according to the component name and the server name comprises:
determining the server of the data tree according to the server name and determining the component linked to the server of the data tree according to the component name, and
determining an attribute linked to the selected component is the target attribute and obtains the target attribute from the data tree.
